(19) United States
(12) Patent Application Publication
(10) Pub. No.: US 2011/0221565 A1
(43) Pub. Date: Sep. 15, 2011

(54) DYNAMIC ACCESS CONTROL IN RESPONSE TO FLEXIBLE RULES

(76) Inventors: Nelson Ludlow, Port Townsend, WA (US); Steven Zehm, Port Hadlock, WA (US); Brian Blood, Port Townsend, WA (US); Tristan Leonard, Port Townsend, WA (US)

(21) Appl. No.: 12/265,666

(22) Filed: Nov. 5, 2008

Related U.S. Application Data
(60) Provisional application No. 60/985,581, filed on Nov. 5, 2007.

(51) Int. Cl. G06F 7/04; G06K 5/00

(52) U.S. Cl. 340/5.6; 235/382

(57) ABSTRACT

A dynamic access control facility that enables an operator to determine whether to grant or deny access to an individual based, in part, on the status of the individual. The operator scans the individual's identification information from an identification record using a scanning device. To determine the status of the individual, the facility decodes the scanned identification information and identifies candidates based on the decoded identification information. The facility may identify a number of candidates or no candidates. For each authorized candidate, the facility selects for display the locations or resources that the candidate is authorized to access. When there is at least one candidate, the facility displays the selected candidate(s) to the operator indicating the status of the individual and/or whether access should be denied or granted. In some embodiments, when no candidates are identified, the facility indicates whether the individual should be denied or granted access.

### CROSS-REFERENCE TO RELATED APPLICATION

This application claims the benefit of U.S. Provisional Application No. 60/985,581 entitled “DYNAMIC ACCESS CONTROL IN RESPONSE TO FLEXIBLE RULES,” filed Nov. 5, 2007.

### BACKGROUND

Identity matching systems have been used in a range of settings to control access to secure locations, protect information against security breaches, and to detect individuals who pose a threat to public safety. For example, many government agencies, as well as corporations, have installed card readers at a number of locations to limit access to authorized individuals holding an identification card. The identification card functions as a key that interacts with the card reader such that, when presented with a card, the reader unlocks the facility to the cardholder. Some identification cards include a picture of the individual to which the card was issued with the intention that unauthorized cardholders may be identified and denied access. Some card readers provide additional security measures by requiring that the cardholder enter a password associated with the identification card before the cardholder is granted access.

The Computer-Assisted Passenger Prescreening System (CAPPS) is another example of an access control system that relies on an identity matching. CAPPS has been used to detect individuals who may pose a terrorist-related threat or who have outstanding Federal or state warrants for violent crimes. When CAPPS identifies an individual, the individual is typically denied (rather than granted) access to the facility (e.g., airplane). In general, access control systems that endeavor to grant (or deny) access to authorized (or unauthorized) individuals require that the individuals be known to the system in advance. Likewise, these systems do not take into consideration environmental information that may impact a decision concerning whether to grant (or deny) access to an unknown individual or an individual that is not authorized.

### BRIEF DESCRIPTION OF THE DRAWINGS

FIG. 1 illustrates a scanning device that may be used to scan an identification record containing machine-readable identification information.

FIG. 2 is a block diagram that illustrates various components or services that are part of or interact with a dynamic access control facility.

FIG. 3 is a flow chart of actions performed by the facility to identify persons of interest based on identification information.

FIGS. 4A, 4B, 4C, and 4D are screenshots of a user interface of the scanning device.

FIG. 5 is a flow chart of actions performed by the facility to determine whether to grant or deny access based on identification information.

FIGS. 6A, 6B, and 6C are screenshots of a user interface of the scanning device depicting access screens.

FIG. 7 is a flow chart of actions performed by the facility to provide an incident report.

FIGS. 8A, 8B, and 8C are screen shots of a user interface of the scanning device depicting incident screens.

FIGS. 9A and 9B illustrate example actions that may be recommended to an operator in connection with granting or denying access to a location or resource.

### DETAILED DESCRIPTION

Accuracy, flexibility, and efficiency are critical factors to the success and adoption of an access control system. In light of the recent security threats in the world, there is a large unmet need to provide better access control at the county's borders, at sensitive installations, and at public and private venues. Accordingly, a dynamic access control facility that is highly accurate and allows individuals to be processed in a short timeframe is disclosed herein. The access control facility is dynamic and responsive to environmental information, such as threat levels issued by the military or the Department of Homeland Security (DHS). The access control facility is also flexible and includes locally-defined access rules.

A dynamic access control facility is disclosed that enables an operator to determine whether to grant or deny access to an individual based, in part, on the status of the individual. The status of the individual includes whether the person is authorized for admission and/or is considered a person of interest. The operator scans the individual's identification information from the identification record using a scanning device. To determine the status of the individual, the facility decodes the scanned identification information and identifies candidates based on the decoded identification information. The facility may identify a number of candidates or no candidates. For example, the facility may identify candidates using a name matching algorithm. For each identified candidate, the facility generates a candidate score. Based on the candidate score of each identified candidate, the facility selects a number of the identified candidates for display. For each selected candidate that the facility recognizes as a person of interest, the facility selects the candidate's criminal acts (or other acts) for display. For each authorized candidate, the facility selects for display the locations or resources that the candidate is authorized to access. In some embodiments, the facility may prioritize the display of certain candidate records, acts, and/or authorizations. When there is at least one candidate, the facility displays the selected candidate(s) to the operator indicating the status of the individual and/or whether access should be denied or granted. In some embodiments, when no candidates are identified, the facility indicates whether the individual should be denied or granted access.

In some embodiments, the facility employs a fuzzy matching technique based on the decoded identification information to identify candidates that are persons of interest. For example, the facility may identify and analyze candidate names that are spelled slightly differently than the name provided by the decoded identification information. The facility may also employ a fuzzy matching technique or an exact matching technique to identify candidates that are not persons of interest and who may be authorized to access particular locations or resources. For example, the facility may first determine whether there is a candidate that exactly matches the decoded identification information and, in the absence of an exact match, the facility may then identify candidates that substantially match the decoded identification information using a fuzzy matching technique (e.g., Levenshtein distance, n-gram distance, etc.).

In some embodiments, the candidate score for each identified candidate is the aggregate result of a multi-factored test. For example, the candidate score may be the aggregate of one or more scores relating to the identified candidate's gender, date of birth (DOB), physical description, or other identifying aspect. In some embodiments, fuzzy matching techniques may be used in calculating the candidate score for each identified candidate. For example, a candidate DOB that exactly matches the DOB provided by the decoded identification information may receive a higher score than a candidate DOB that matches the day and month yet does not match the year of the DOB provided by the decoded identification information.

In some embodiments, the candidate score includes a score that is calculated according to the frequency of the candidate's name within a population. For example, a candidate name having a high frequency within a population (e.g., John Smith) may receive a lower score than a candidate name having a low frequency within the population (e.g., Walentia Knapek).

In some embodiments, the number of identified candidates selected for display by the facility is based on environmental information known or retrieved by the facility. For example the facility may obtain the environmental information from an external service; such information may include threat levels issued by the military or DHS. When the threat level is high, the facility may display additional person of interest candidates to the operator. In some embodiments, the user interface is configurable. The facility may display multiple person of interest candidates or acts (criminal or other) to the operator.

In some embodiments, the facility may determine that scanned identification information matches or substantially matches a record corresponding to a person of interest and an authorized person. That is, the individual may be a person of interest and also be authorized to access a particular location or resource. For example, the facility may identify an individual as a person of interest because he or she owes past due child support and/or has a civil arrest warrant for failing to appear on a court date. However, the identified individual may also be authorized to access a particular base or resource because he or she is, for example, a marine. Based on the person of interest category, environment information, and/or one or more access rules, the facility determines whether the individual should be granted or denied access. In some embodiments, the access rules may include “locally-defined” access rules. As used herein, locally-defined access rules are rules defined for use at one or more particular locations. For example, locally-defined access rules may be generated for use at all security entrances at which a scanning device is operating on a particular corporate campus.

In some embodiments, the facility may determine that the scanned identification information does not match or substantially match a record corresponding to a person of interest or a record corresponding to an authorized person. That is, no records may be identified. In such embodiments, the facility determines whether the individual should be granted or denied access based on environmental information and/or one or more access rules. For example, even though a lieutenant may not be expressly authorized to access a particular military base (i.e., the lieutenant is not an authorized list for that base), the facility may determine that the lieutenant is to be granted access by virtue of the lieutenant's rank and absence of other circumstances that would warrant denying access. The facility may include an access rule regarding the type of identification scanned. In this example, the facility can grant access to the lieutenant when the type of identification presented is a military ID, yet deny access to the lieutenant when the type of identification presented is a driver's license.

In some embodiments, the access rules have an order of precedence. For example, the facility may include a rule regarding a threshold threat level. Continuing the previous example, when the threat level exceeds the threshold level, the facility may deny access to the unauthorized lieutenant despite rules having a lower precedence order that indicate access should be granted (e.g., because a military ID was scanned).

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

Various embodiments of the invention will now be described. The following description provides specific details for a thorough understanding and enabling description of these embodiments. One skilled in the art will understand, however, that the invention may be practiced without many of these details. Additionally, some well-known structures or functions may not be shown or described in detail, so as to avoid any unnecessarily obscuring the relevant description of the various embodiments.

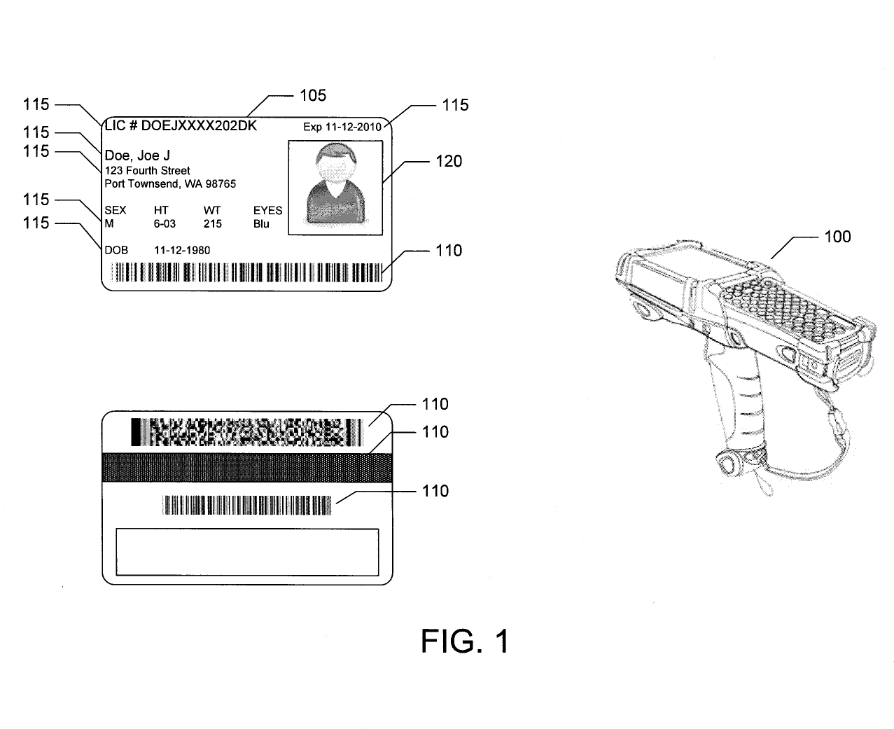

FIG. 1 illustrates a scanning device 100 that may be used to scan an identification record 105 containing machine-readable identification information encoded in, for example, one or more bar codes or magnetic strips 110, or a radio-frequency identification (RFID) chip (not shown). When an individual provides an operator of scanning device 100 with identification record 105, the operator may scan the identification record to determine whether to grant or deny an individual access to a location or resource. With scanning device 100, for example, the operator may determine that the individual is a suspected terrorist, has an outstanding warrant, or is otherwise wanted by the authorities. As another example, with scanning device 100, the operator may determine that the individual is authorized to access a secure location, such as a military base or airport terminal. Further details about the scanning device will be provided herein.

Identification record 105 may be a driver's license or other form of identification record containing machine-readable identification information. In some embodiments, for example, identification record 105 may be a military or federal government identification document (“ID”), state or local government ID, passport, credit card, bank card, student ID, or corporate ID. In some embodiments, the identification record includes one or more portions of human-readable information 115. Identification record 105 may include information such as the individual's name, address, DOB, signature, or physical characteristics. In some embodiments, identification record 105 includes a photograph 120 of the individual. The information on the identification record may be stored as human-readable information, as machine-readable information, or as both human-readable and machine readable information.

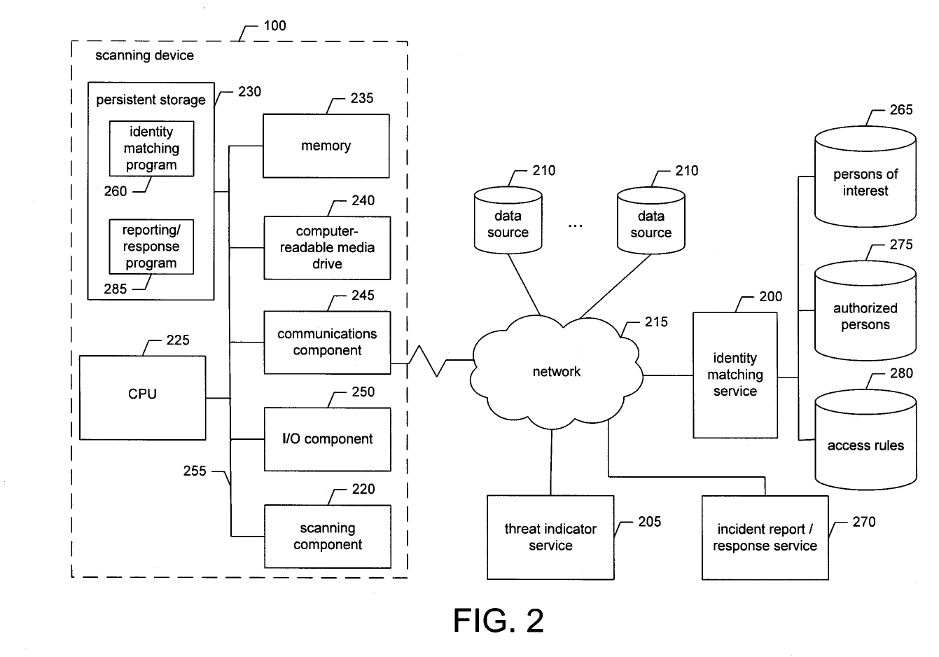

FIG. 2 is a block diagram that illustrates various components or services that are part of or interact with a dynamic access control facility. As illustrated in FIG. 2, the scanning device 100, an identity matching service 200, a threat indicator service 205, an incident report/response service 270, and a plurality of data sources 210 may exchange data through a wired or wireless network 215 in order to enable the facility to dynamically determine whether an individual should be granted or denied access to a location or resource. Scanning device 100 shows some of the components that may be incorporated in a device on which the facility executes. In the illustrated embodiment, scanning device 100 includes one or more scanning components 220. For example, the scanning device may include a digital scanner, a magnetic reader, a one-dimensional (“1D”) bar code scanner, a two-dimensional (“2D”) bar code scanner, an RFID reader, or other scanning component. Note, however, that the device 100 does not have to include a scanning component 220. For example, the scanning components may be implemented by a separate system that provides scanned information as input to the device 100 for processing as described herein.

The scanning device also includes one or more central processing units (CPUs) 225 for executing computer programs; a persistent storage component 230, such as a hard drive for persistently storing programs and data; a computer memory 235 for storing programs and data while they are being used; a computer-readable media drive 240 for reading programs and data stored on a computer-readable medium; a communications component 245 for connecting the scanning device to other computer systems; and one or more input/output components 250, such as a display, keyboard, or touch screen; all of which may exchange data via a bus 255 or other communication path. While scanning devices configured as described above are typically used to support the operation of the facility, those skilled in the art will appreciate that the facility may be implemented using devices of various types and configurations, and having various components.

In some embodiments, scanning device 100 executes an identity matching program 260 to determine whether to grant or deny access to the individual, and this determination may be based on the status of the individual, for example. That is, the determined status may be used to determine whether the individual is authorized to access a location or resource and/or whether the individual is considered a person of interest. The determined status of an individual may include one or more of the status types listed in Table 1.

TABLE 1

| REFERENCE NO. | DESCRIPTION |
|---|---|
| 1 | BOLO (“Be On the Look Out for”) Terrorist |
| 2 | BOLO Violent |
| 3 | BOLO Nonviolent |
| 4 | Debarment |
| 5 | Fake ID |
| 6 | Lost/Stolen ID |
| 7 | Terminated ID |
| 8 | Suspended ID |
| 9 | Persona-Non-Grata |
| 10 | EAL (“Entry Authorized List”) - Not Authorized |
| 11 | Expired ID |
| 12 | EAL - Authorized |
| 13 | VIP (“Very Important Person”) |
| . . . | . . . |
| N | Valid ID |

It is noted that the status types listed in Table 1 may include other types not listed here. As will be described in additional detail herein, the status of an individual may be used as a factor in the determination of whether the individual is authorized for access and/or considered a person of interest, displayed to an operator of the scanning device, included in a report associated with the scanned identification, and/or transmitted to an authority for further processing, etc.

Information records identifying persons of interest may be stored locally on scanning device 100 and/or be accessed remotely by the scanning device. Similarly, information records identifying authorized persons may be stored locally on scanning the device 100 and/or be accessed remotely by the scanning device. For example, the scanning device may include a database (not shown) containing identification records from one or more data sources 210. Such data sources may include, for example, databases or web sites maintained by the FBI, Immigration and Customs Enforcement, U.S. Secret Service, Drug Enforcement Agencies, Interpol, U.S. Postal Service, State Law Enforcement Agencies, U.S. Air Force, U.S. Coast Guard, U.S. Marshals, Navy/Marine Corps, Attorney General's Office, Department of Corrections, Department of Public Safety, state or national sex offender registry, county law enforcement agency, sheriffs office Most Wanted, city law enforcement agency, National Crime Information Center (NCIC), state or federal active warrants, Crime Stoppers, America's Most Wanted, Bail Jumpers, or other public or private sources of data such as a corporate employee database, airline databases, etc.

In some embodiments, the information contained in data sources 210 is aggregated to produce one or more data stores, such as a persons of interest data store 265. In addition, the system operator or third party may provide information about individuals that are aggregated to produce an authorized persons data store 275. By aggregating the data sources, a greater quantity of information and/or more accurate information about a person can be easily, quickly, and reliably obtained than if information from each data source were used in isolation. Also, by aggregating data sources, the amount of information (e.g., the number of records) considered by the identity matching service may be significantly reduced thereby increasing the performance of the facility. A technique for aggregating such information, which is suitable for this purpose, is described in commonly-owned, co-pending U.S. patent application Ser. No. 12/197,188, filed on Aug. 22, 2008 and entitled, “AGGREGATION OF PERSONS-OF-INTEREST INFORMATION FOR USE IN AN IDENTIFICATION SYSTEM,” which is herein incorporated by reference. However, it will be appreciated that the facility may use other data aggregation techniques.

In some embodiments, the scanning device includes a database (not shown) containing identification records from one or more data sources, such as identification records mirrored from a remote data store 265 and/or authorization information mirrored from a remote data store 275. While in other embodiments, the scanning device accesses remote data store 265 and/or 275 through a public or private network 215.

The persons of interest data store is a database of individuals having one or more criminal or other acts that cause them to raise heightened concern for security purposes. In addition to a record of the criminal and other acts of each individual, the persons of interest data store includes typical characterizing information about the individual, such as a picture, name, DOB, gender, height, weight, eye color, address, etc. The authorized persons data store is a database of individuals that may have permission to access one or more secure locations or resources. In addition to authorization information, the authorized persons data store may similarly includes descriptive information about the individual, such as a picture, name, date of birth, age, sex, social security number, title, rank, etc.

The information records contained in the persons of interest data store and the authorized persons data store are used to identify individuals of interest and/or to determine whether an individual should be denied or granted access to a location or resource. In some embodiments, the facility calls a remote identity matching service 200 to determine the status of an individual based on the scanned identification information. In some embodiments, the facility may invoke a local identity matching program 260 to determine the status of an individual based on the scanned identification information. It will be appreciated that the identity matching service and the identity matching program may also work in combination to process identity and/or access control information. The actions taken by the facility to determine the status of an individual is described further herein.

In some embodiments, to determine whether an individual should be granted or denied access, scanning device 100 executes one or more access rules. The one or more access rules may be defined for the location in which the scanning device is operating. Some access rules may also be defined globally (i.e., across all scanning devices) or locally for one or more of locations in which the scanning device operates. In some embodiments, when the location of the scanning device changes, another set of access rules are applied. The one or more access rules may be stored locally on scanning device 100 and/or be accessed remotely by the scanning device. For example, the scanning device may include a database (not shown) containing access rules from one or more data sources, such as access rules mirrored from a remote access rules data store 280. As another example, the scanning device may not maintain a local database and instead may access remote data store 280 through a public or private network 215. The access rules data store is a database of access rules. In some embodiments, the access rules have an order of precedence, that is, certain rules may take priority over other rules.

In some embodiments, the facility calls a remote incident reporting/response service 270 to capture information relating to an incident. In some embodiments, the facility may invoke a local reporting/response program 285 to capture information relating to an incident. It will be appreciated that the incident reporting/response service and the incident reporting/response program may also work in combination to process incidents and manage reports.

There may be various types of incidents. Incidents may range in severity and/or be based on access rules and/or be based on a determined status of the individual. For example, an incident may be the result of a scan that identifies an individual who is a violent felon (“BOLO Violent”) or terrorist (“BOLO Terrorist”). As another example, an incident may be the result of denying an unauthorized lieutenant access to a base when the threat level is above a defined threshold.

In some embodiments, the severity of the incident triggers one or more reporting requirements. For example, some incidents (e.g., terrorist identification) may require the operator to both record the incident and contact the appropriate authorities. In some cases the scanning device may prevent the operator from performing any new scan until the incident is reported. In other cases, the operator may defer recording the incident until a later or more convenient time. In some embodiments, an operator of the scanning device may not be aware that a report is generated and/or transmitted as a result of scanning identification presented by an individual. For example, although it may be desirable to have an operator question and/or detain an individual who attempts to access elementary school property when the individual is listed on a sex offender registry, such actions may not be appropriate when the same individual attempts to access a public library (or court). However, it may still be useful to generate and/or transmit a report as a result of the scan. For example, if a child is kidnapped from the library, it may be useful to review incident reports associated with prior accesses that would otherwise be considered innocuous.

In some embodiments, incident reports are manually entered by the operator and/or automatically entered by the facility. For minor incidents, for example, the facility may generate a report automatically without operator input. As a result, the operator may continue his or her activities without interruption. However, the operator may edit (e.g., include remarks) any portion of a report automatically generated by the facility.

In some embodiments, the reporting requirements, as well as the types and severity of incidents, are configurable. In some embodiments, only certain administrators of the facility and/or operators may configure the reporting requirements.

While various embodiments are described in terms of the environment described above, those skilled in the art will appreciate that the facility may be implemented in a variety of other environments including a single monolithic computer system, as well as various other combinations of computer systems or similar devices connected in various ways.

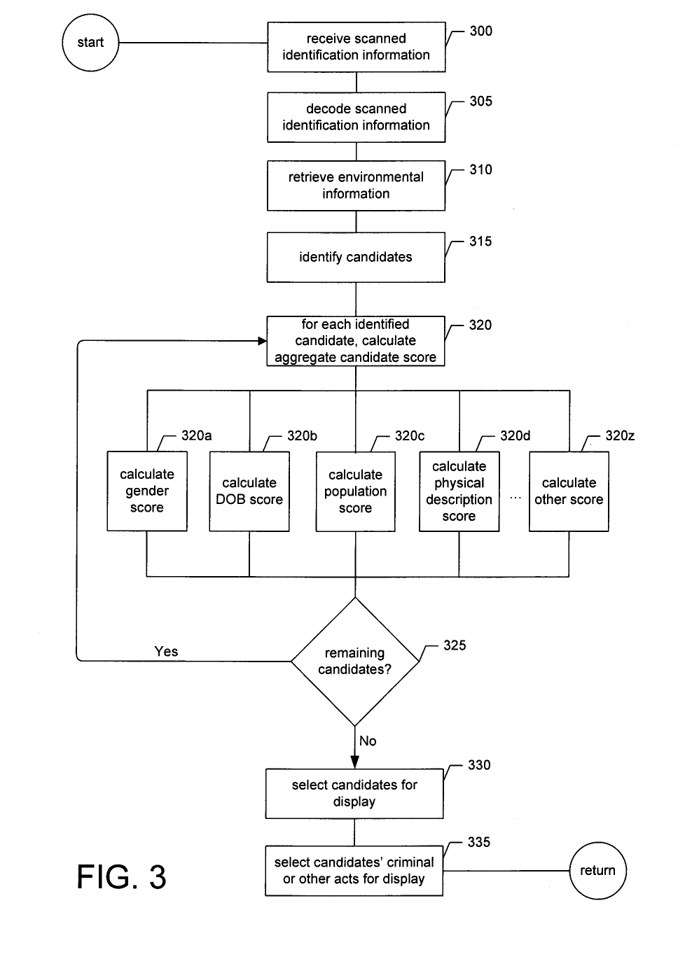

FIG. 3 is a flow chart showing actions performed by the facility to identify persons of interest based on identification information. At block 300 the facility receives scanned identification information. At block 305, the facility decodes the scanned identification information. In some embodiments, the facility parses the decoded identification information into one or more query fields. For example, when an operator scans identification record 105 containing machine-readable identification information, the facility may parse the decoded information into a query name field, query license number field, query DOB field, query image field, query gender field, query height field, query weight field, query eye color field, query address field, etc.

At block 310, the facility retrieves environmental information. Environmental information may be retrieved from local or remote data sources. For example, the facility may ascertain the threat level issued by DHS. The Homeland Security Advisory System is a color-coded threat advisory scale, consisting of five color-coded threat levels: red (severe risk), orange (high risk), yellow (significant risk), blue (general risk), and green (low risk). The different levels trigger specific actions by federal agencies and state and local governments. Typical actions include increasing police and other security presence at landmarks and other high-profile targets, more closely monitoring international borders and other points of entry, etc. The facility may ascertain environmental information from a number of agencies and/or news facilities, and is not limited to DHS. As another example, the facility may retrieve the details of an AMBER Alert. Environmental information may also include information relating to the date and time, location of the scanning device, etc.

The environmental information used by the facility may be updated in real-time, in near real-time, or on a periodic or sporadic basis. For example, the facility may send a query to a service to receive the threat level issued by DHS each time that it receives scanned identification information. As another example, the facility may receive a periodic (e.g., hourly, daily) data feed from the DHS or from another service that contains the threat level. The threat level is stored by the facility and continued to be used until an updated threat level is received. As yet another example, the threat level may be queried by the facility on a daily basis and used until a new threat level is obtained.

The environmental information considered by the facility may be a single threat level provided by a service, or it may encompass multiple pieces of information derived from a variety of sources. For example, the facility may take into account a national government threat level, a time of day, a regional warning, and a report of two incidents (e.g. robberies) that took place in proximity to the scanning device. The facility may apply various weighting factors to each of the pieces of information to arrive at an overall assessment of the threat level for subsequent processing.

At block 315, the facility identifies a number of potential candidates that match the identity of the individual with the ID based on the decoded identification information. The facility identifies candidates based on how closely the candidate name matches the query name. In some embodiments, the facility identifies the candidates using a fuzzy name matching algorithm. The identified candidates may match the decoded identification information exactly or approximately. The facility may use a number of techniques individually or in combination to identify candidates. For example, the facility may identify candidates using the bitap algorithm. The bitap algorithm is a fuzzy matching algorithm that determines whether a query string is approximately equal to a selected string based on the minimum number of operations necessary to transform one string into the other, where an operation is an insertion, deletion, or substitution of a single character. If the query string and pattern are within a predefined distance k of each other, then the bitap algorithm considers them approximately equal.

In some embodiments, the facility identifies the candidates by phonetically encoding the decoded identification information to capture its phonetic representation. The Soundex algorithm or International Phonetic Alphabet (IPA) algorithm are examples of phonetic algorithms that may be used to normalize spelling errors or detect variants. In some embodiments, the facility selects a phonetic algorithm based on the origin of the query name. The facility may also identify candidates by considering variants of a query name; for example, Finetta is a variant of Josephine.

The number of candidates identified by the facility may be predefined. For example, the facility may be configured to identify a minimum or maximum number of candidates. In some embodiments, the number of identified candidates is based on environmental information known or retrieved by the facility. For example, the facility may identify a greater number of candidate records when the threat level is high, and a lesser number of candidates when the threat level is low. By varying the number of candidates that are identified for processing by the facility, the facility may increase the likelihood of locating a match. A greater number of candidates, however, may result in lengthier processing times that could potentially impact the number of individuals that can be processed by an operator.

At block 320, for each identified candidate, the facility generates a candidate score based on the sum of scores calculated at blocks 320a, 320b, . . . 320z. Each of the scores calculated at blocks 320a, 320b, . . . 320z may be weighted depending on how strongly the score is correlated with a potential candidate match. The overall candidate score indicates how likely the candidate record and the scanned identification record identify the same individual.

At block 320a, the facility calculates a gender score based on how closely the candidate's gender matches the query gender. For example, when the candidate's gender matches the query gender, the facility may assign a higher score than when the there is no match or when the gender of the candidate is unknown. In some embodiments, when a candidate record indicates that a candidate uses gender disguises or aliases, the facility may assign the same score regardless of whether the query gender is male, female, or unknown.

At block 320b, the facility calculates a DOB score based on how closely the candidate's DOB matches the query DOB. The candidate's DOB may match the query DOB exactly or approximately. In some embodiments, the facility uses a fuzzy matching algorithm to calculate the DOB score. For example, when the candidate's DOB matches a portion of the query DOB (e.g., day and month), the facility may assign a higher score than when there is no match. In some embodiments, the facility may assume a match for a portion of the query DOB when the query DOB is not within an acceptable range. For example, when the query DOB is Mar. 32, 1980, the facility may assign the same score to all identified candidates having a DOB in March 1980.

At block 320c, the facility calculates a population score based on the frequency of the query name within the population. For example, a query name having a high frequency within a population (e.g., John Smith) may be scored lower than a query name having a low frequency within the population (e.g., Walentia Knapek). In some embodiments, the population from which the frequency data is derived may be the persons of interest data store from which the candidate records are identified.

At block 320d, the facility calculates a physical description score based on how closely the candidate's physical description matches the query physical description. For example, the facility may compare the candidate's height, weight, eye color, hair color, etc. In some embodiments, when calculating the candidate physical description score, the facility values certain characteristics over others. For example, a match relating to height may be assigned a higher score than a match relating to hair color because hair color (unlike height) is easily changed. In some embodiments, the facility uses fuzzy matching techniques to calculate the physical description score. For example, when the candidate height is within 2-3 inches of the query height, the facility may assign a higher score than when the candidate height outside of an acceptable range. As another example, the facility may assign a high score when the query hair color is red and an identified candidate's hair color is indicated as blonde and/or red.

Other scores may be calculated for the individual. In some embodiments, each candidate score may also include a name matching score indicating how closely the candidate's name matches the query name. The name matching score may be based in whole or in part on the methodology used by the facility at block 315, or it may be generated independently from the facility's identification of candidate records.

At block 325, the facility determines whether there are remaining candidates for which candidate scores have not been calculated. If there are remaining candidates, the facility returns to block 320 to generate the next candidate's score. Otherwise, the facility continues to block 330 to select the candidates for display. In some embodiments, the facility selects candidate for display based on the candidate scores. For example, the facility may select only candidate records scoring above a predefined threshold candidate score. When very few (or no) candidate records are selected for display, the operator may elect to lower the threshold candidate score to select candidates for display. In some embodiments, the number of candidates selected for display is predefined. For example, the facility may be configured to select a minimum or maximum number of candidates for display (with or without regard to a threshold candidate score).

In some embodiments, the number and type of candidates that are selected for display may be based on the retrieved environmental information. By varying the number of candidates that are displayed to the operator, the facility allows a greater or lesser degree of scrutiny to be applied to the individual being verified. In times of an increased threat level, operators may desire to see a greater number of candidates even though it may slow down processing of a particular individual. In times of a reduced threat level, operators may desire to see a lesser number of candidates to increase the number of individuals that can be processed, provided that overall security is not unreasonably lowered. The facility may also select the candidates to display based on the type of threat presented. For example, when the facility detects an AMBER Alert, it may prioritize the selection of records identifying candidates suspected, charged, or convicted of kidnapping or other crimes involving children. As another example, when the facility detects a threat level indicating a severe risk of a terrorist attack, the facility may prioritize the section of records identifying candidate suspected, charged, or convicted of acts involving terrorism.

At block 335, if a selected candidate has more than one criminal or other act, the facility prioritizes the display of the criminal or other acts associated with the selected candidate. In some embodiments, the facility ranks the candidate's criminal or other acts according to a predetermined order. For example, if a record indicates that a candidate is both a terrorist (Terrorist BOLO) and has an outstanding arrest warrant for felony embezzlement (Non-Violent BOLO), the facility may select for display first an indication that the candidate is a Terrorist BOLO and second an indication that the candidate is a Non-Violent BOLO. In some embodiments, candidate's acts are ranked according to the highest threat presented by the candidate. This rank order may be configured dynamically in some circumstances, and/or it may be based in part on environmental information known to the facility. After block 335, the facility returns.

In some embodiments, the facility performs similar actions to those identified in blocks 300-335 to identify candidates who may be authorized to access a location or resource. While in other embodiments, the facility identifies candidates based on an exact match between the decoded identification information and specific record information (e.g., full name and/or identification number).

Those skilled in the art will appreciate that the blocks shown in FIG. 3 may be altered in a variety of ways. For example, the order of blocks may be rearranged; sub-blocks may be performed in parallel; shown blocks may be omitted; or other blocks may be included; etc.

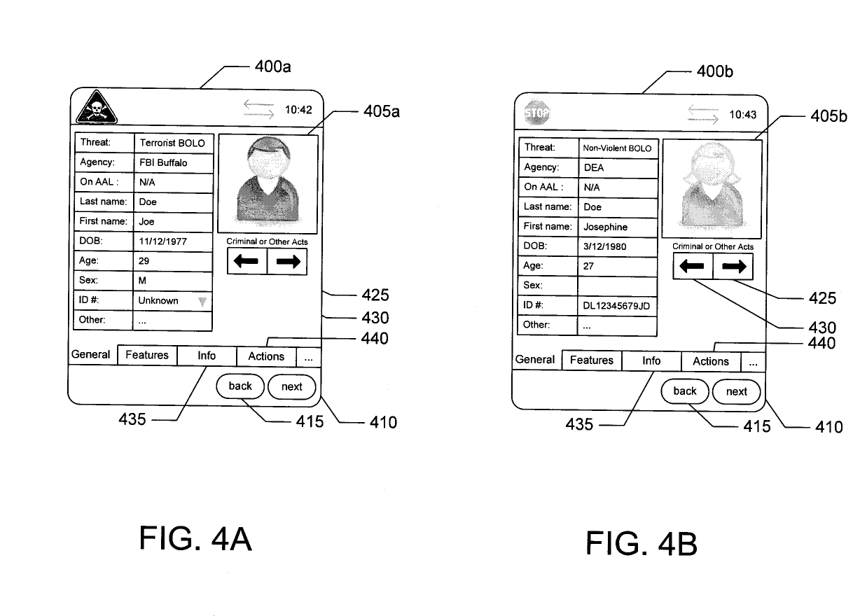

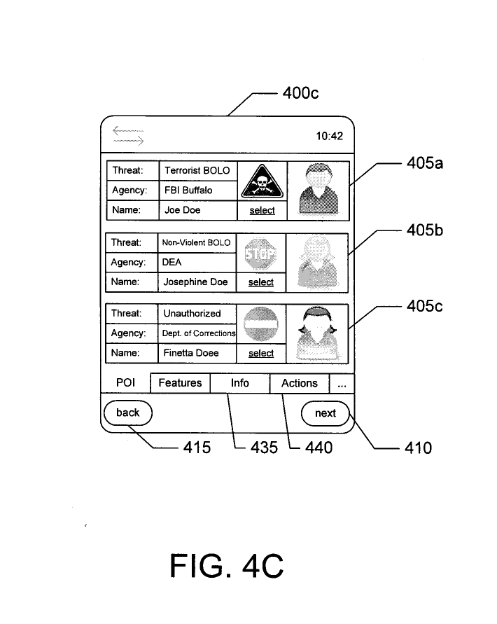

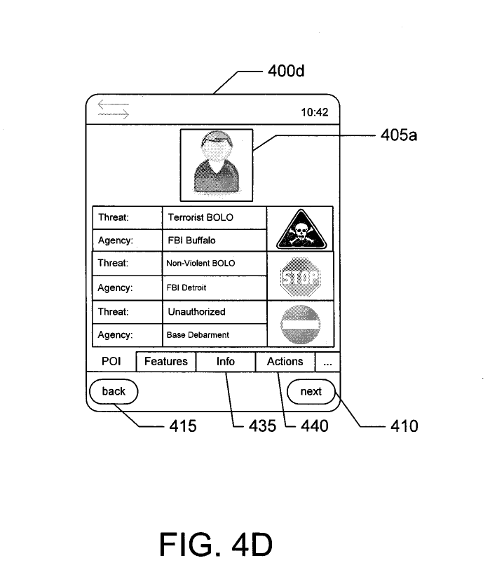

FIGS. 4A, 4B, 4C, and 4D show sample screenshots presented as part of the user interface. In particular, displays 400a, 400b, 400c, and 400d are representative screen images that may be displayed by the facility after the scan of an identification record 105 by an operator of scanning device 100. Candidate records 405a, 405b, 405c, . . . 405z have been identified and selected for display by the facility based at least in part on the scanned machine-readable identification information. An image of each candidate may be displayed, along with one or more pieces of data that may be used to identify the candidate. For example, the first name, last name, date of birth, age, sex, and other features may be displayed to the operator. In addition, the highest priority criminal or other act selected by the facility is displayed to the operator. The operator may select other acts associated with the candidate by selecting a forward control 425 or backward control 430.

The operator can navigate among various candidate records that are chosen for display by the facility using controls 410 and 415. Pressing the next control 410 causes the operator to see the next candidate selected for display by the facility. Pressing the back control 415 causes the operator to see the previous candidate selected for display. One skilled in the art will appreciate that the user interface could be implemented in a variety of ways to enable an operator to navigate among records. Scroll bars, for example, could be provided. FIGS. 4A and 4B show how an operator navigated from a first record 405a shown in display 400a to a second record 405b shown in display 400b using the control 410 of display 400a.

In some embodiments, the operator establishes preferences by providing an operator profile indicating the operator's preferred display views and/or display controls. For example, an operator may indicate that he or she prefers to view a single matching candidate record and a single act per display (as is shown in FIGS. 4A and 4B). As another example, the operator may indicate that he or she prefers to view multiple matching candidate records and a single act for each candidate per display (as shown in FIG. 4C), or a single matching candidate record and multiple acts per display (as shown in FIG. 4D). One skilled in the art will understand that an operator may establish a variety of viewing preferences. Some operators may prefer to switch between views, such that the first display provides an overview of matching records (as shown in FIG. 4C), while subsequent views permit the operator to drill down into the details of each record (as shown in FIGS. 4A, 4B, and 4D).

In some embodiments, the operator can add (or delete) display fields, such as a field that shows the candidate score (not shown). The operator may also establish a display preference that does not display fields for which the information in unknown to the facility. For example, if this display preference were activated for display 400a, the ID# field for record 405a would not display because the facility does not have an ID number associated with that candidate.

In some embodiments, additional information describing the threat or threats presented by a candidate may be provided by the facility. For example, the operator may learn additional details regarding the criminal or other acts of a candidate by using a control 435 to navigate to a detailed record display (not shown). In some embodiments, these details are retrieved dynamically by the facility from a remote service when they are requested by the operator. In other embodiments, these details (or details for particular types of threats) are stored locally on the scanning device.

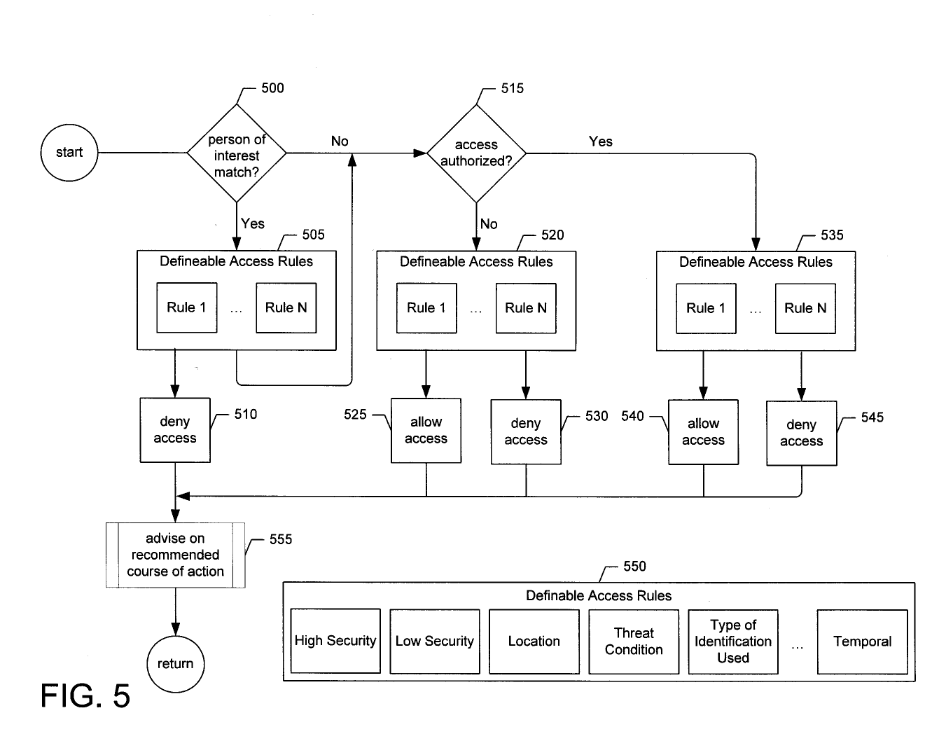

FIG. 5 is a flow chart of actions performed by the facility to determine whether to grant or deny access to an individual based on identification information. At decision block 500 the facility determines whether the individual is a person of interest. That is, the facility assesses whether the identification information associated with the individual matches or substantially matches a candidate record in the person of interest data store. If the facility determines that the individual is likely a person of interest, then the facility continues to block 505.

At block 505, the facility may apply one or more access rules to determine whether the individual is eligible for access to the requested location or resource despite being a person of interest. In order to determine whether access should be granted, the facility may apply one or more rules that take into account such factors as the severity of crime or act, the requested location or resource, the current environmental information, etc. In some embodiments, the facility may analyze the attributes characterizing the person in order to determine a relative level of danger posed by the person. While in other embodiments, the relative level of danger of a person may be stored in the record associated with the person of interest Based on the applied access rules, the facility may grant access to an individual even though he or she is a person of interest. For example, an individual may be granted access to a location or resource when he or she owes past due child support and has a civil arrest warrant for failing to appear on a court date, if the civil matter is deemed irrelevant for access purposes. When applying access rules, the access rules may have an order of precedence. For example, when there is a felony arrest warrant for a violent crime or act of terrorism associated with a candidate record that reflects the identity of the individual, the facility may determine that access should be denied under all circumstances.

If the facility determines that the individual should be denied access based on the application of the access rules, the facility denies access at block 510. Processing then continues at block 555 where the facility advises the operator of the scanning device on the recommended course of action, as described below. In some embodiments, this may include prompting the operator to take an action in connection with denying the individual access to the location or resource.

If the facility determines that the individual is not a person of interest at decision block 500, or determines that the individual is eligible for access even though he or she is likely a person of interest at block 505, then processing continues at decision block 515. At decision block 515, the facility determines whether the individual is authorized to access the requested location or resource. That is, the facility assesses whether the identification information associated with the individual matches or substantially matches a candidate record in the authorized persons data store. For example, authorized persons may be identified when there is an exact match between the scanned identification information and the authorized persons information, when there is an exact name match or an exact name match and birth date match, or when there is a fuzzy match between the scanned identification information and the authorized persons information (e.g., when the authorized candidate name is “Jeff Green” and the scanned identification name is “Jeffrey Green”).

If the facility determines that the individual is not authorized to access the location or resource at decision block 515, then the facility continues to block 520. At block 520, the facility may apply one or more access rules to determine whether the individual is eligible for access to the requested location or resource despite not being explicitly authorized. In order to determine whether access should be granted, the facility may apply one or more access rules that take into account such factors as whether the individual was previously identified as a person of interest, whether the individual is expressly unauthorized, environmental information (e.g., threat level, time, date, etc.), the type of identification scanned, the type of location or resource, any express rules (e.g., “only grant access authorized individuals”), etc. Based on the rules, the facility may grant access to an individual even though he or she is not specifically authorized. For example, even though a lieutenant may not be explicitly authorized to access a particular military base, the rules may be defined by the facility operator to ensure that, as an officer, the lieutenant is granted access. The facility may include one or more rules that take into account the type of identification scanned. For example, the facility may grant access to the lieutenant when the identification presented is a military ID, yet deny access to the lieutenant when the identification presented is a driver's license. In some embodiments, the access rules have an order of precedence. That is, certain rules may take priority over other rules. If the facility determines that access should be allowed based on the application of the access rules, the facility allows access at block 525. If the facility determines that access should be denied based on the application of the access rules to the person of interest, the facility denies access at block 530. In each case, processing continues at block 555 where the facility advises the operator of the scanning device on the recommended course of action. In some embodiments, this may include prompting the operator to take an action in connection with granting or denying the individual access to the location or resource.

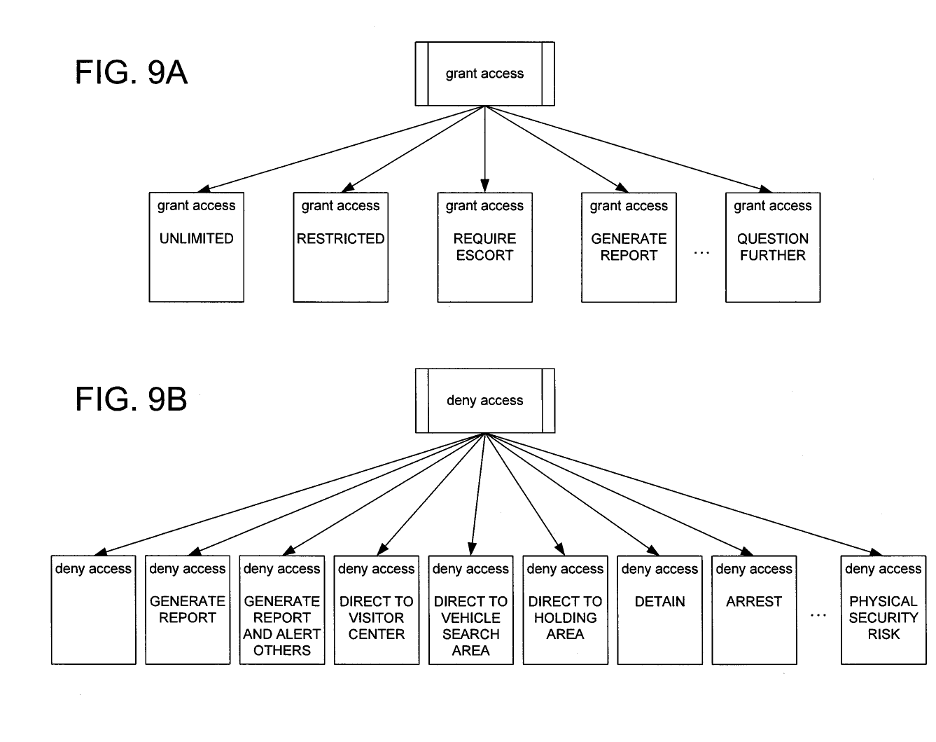

If the facility determines that the individual is authorized to access the requested location or resource at decision block 515, the facility continues to block 535. At block 535, the facility may apply one or more access rules to determine whether the individual should be denied access to the location or resource despite being expressly authorized. In order to determine whether access should be granted or denied, the facility may apply one or more access rules that take into account such factors as whether the individual was previously identified as a person of interest, the environmental information (e.g., threat level, time, date, etc.), the type of identification scanned, the type of location or resource, etc. Based on the rules, the facility may deny access to an individual even though he or she is otherwise specifically authorized. For example, the facility may include one or more rules regarding a threshold threat level. When the threat level exceeds the threshold level, the facility may deny access to any individual or individuals without VIP qualifications. For example, an otherwise authorized lieutenant may be denied access under certain lockdown conditions at a military base. If the facility determines that access should be allowed based on the application of the access rules, the facility allows access at block 540. If the facility determines that access should be denied based on the application of the access rules to the person of interest, the facility denies access at block 545. In each case, processing continues at block 555 where the facility may advise the operator of the scanning device on a recommended course of action. In some embodiments, the advice may include prompting the operator to take some action in connection with granting or denying the individual access to the location or resource. FIGS. 9A and 9B illustrate example actions that may be undertaken by an operator in connection with granting or denying the individual access to the location or resource. For example, when an individual presents an expired ID in an attempt to access a government facility, the individual may be granted access the first time (or a pre-defined number of times) and the operator of the scanning device may be prompted to warn the individual that future access attempts with the expired ID will be denied. As another example, an operator may be promoted to require an individual with an expired ID to be escorted until the ID is reinstated. It is noted that other actions (or inactions) not illustrated in FIG. 9A or 9B may be undertaken by an operator in addition to or in place of the one or more of the illustrated actions.

Returning to FIG. 5, it will be appreciated that the number and type of access rules, generically represented by access rules 550, may be varied by the facility depending on the particular application, the desired level of security, and other factors. The rules may be manually configured by an operator of the facility, or automatically configured by the facility. The rules may be applied at certain times of the day, and not applied at other times of the day. The rules may be applied at certain locations, and not applied at other locations. The facility may therefore be flexibly applied to suit the particular use of the scanning device. Those skilled in the art will also appreciate that the blocks shown in FIG. 5 may be altered in a variety of ways. For example, the order of blocks may be rearranged; sub-blocks may be performed in parallel; shown blocks may be omitted; or other blocks may be included; etc.

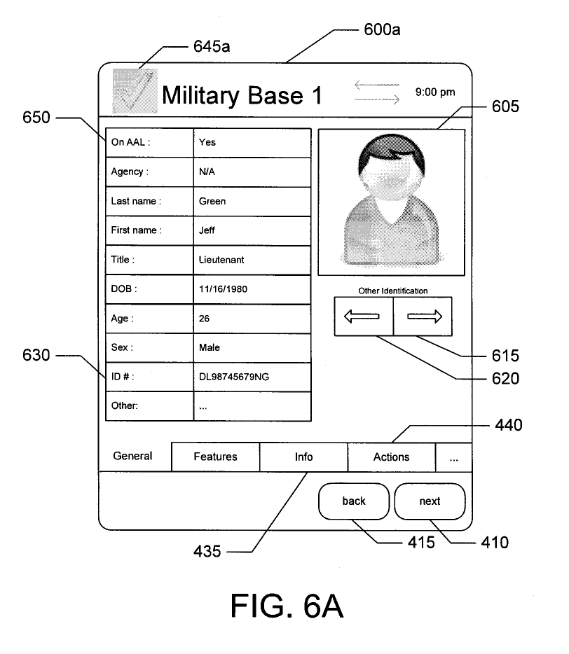

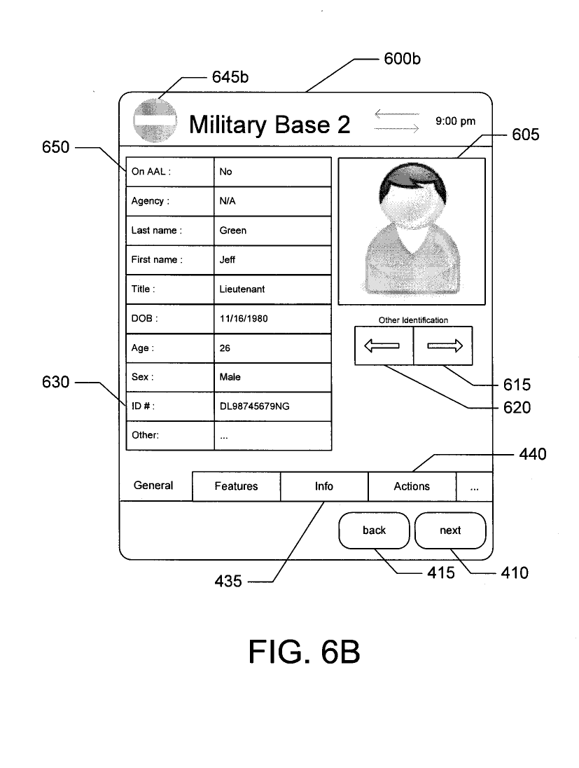

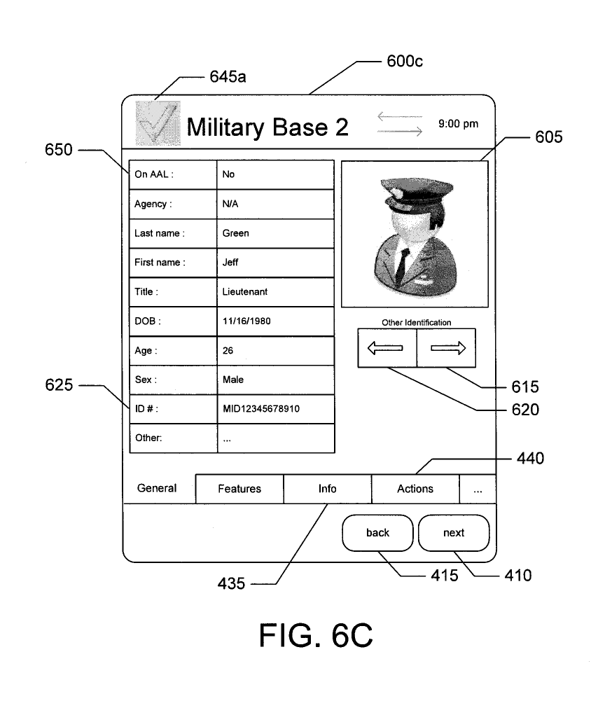

FIGS. 6A, 6B, and 6C show sample screenshots of access screens presented as part of the user interface. In particular, display 600a is a representative screen image that may be displayed by the facility after a scan of an identification record matching a candidate record 605. An image of the candidate may be displayed, along with one or more pieces of information that may be used to identify the individual. For example, the first name, last name, date of birth, age, sex, social security number, title, rank, and other features may be displayed to the operator. In some embodiments, the operator can navigate among multiple identification records for a single individual by selecting a forward control 615 or a backward control 620. For example, FIGS. 6B and 6C reflect two different identification records for the same individual. FIG. 6B reflects an access screen based on a driver's license (as indicated by a driver's license number 630) and FIG. 6C reflects an access screen based on a military ID (as indicated by a military ID number 625). When more than one candidate record is selected by the facility for display, the operator can navigate among the selected candidate records (not shown) using controls 410 and 415.

In some embodiments, the facility displays a symbol at the top of the access screen to indicate whether the candidate is granted or denied access to a particular location or resource. For example, a check mark icon 645a may be displayed at the top of the screen to indicate that the candidate has access to the noted location (“Military Base 1” in FIG. 6A and “Military Base 2” in FIG. 6C). As another example, a “do not enter” icon 645b may be displayed to indicate that the candidate has been denied access to the noted location (“Military Base 2 in FIG. 6B). The facility may also show whether the candidate is authorized to access the location by displaying an indication in field 650 that the candidate record is on an entry authorization list (“EAL”) for the requested location or resource. By indicating whether the candidate is granted or denied access and whether the candidate is on the EAL for the requested location or resource, the operator can determine whether the facility based its determination on an access list or on one or more access rules. Although specific locations are mentioned to facilitate description, it is noted that operation of the facility is not limited to the mentioned locations. For example, the facility may be used to control access at variety of locations, such as airports, sea ports, boarders, government facilities, commercial facilities, military installations, medical facilities, courts, nuclear power plants, and other locations. It is also noted that locally-defined access rules, or rules that apply only to a single location or a group of locations, may be defined and utilized at one or more of these locations.

It will be appreciated that, in some embodiments, to accurately display the access rights of an individual, the facility is aware of the location in which the scanning device is operating. For example, the location of the scanning device may be manually entered by an operator of the device, or automatically determined by the scanning device (e.g., using GPS or other sensing technology). Once the location of the scanning device is determined, appropriate rules pertaining to access at that location or resource may be manually or automatically downloaded or otherwise communicated to the scanning device.

The facility may also provide additional information describing the access rights of the candidate and/or access rules used by the facility to grant of deny access. For example, the operator can learn additional details regarding the locations and/or resources for which the displayed candidate is authorized to access by using control 435 to navigate to a detailed record display (not shown). In addition, when a candidate is denied (or granted) access to a requested location or resource, the operator can navigate to the detailed record using control 435 to understand the basis for the denial (or grant).

FIGS. 6B and 6C also show an application of an access rule that is based on the form identification presented by the individual. As shown in FIG. 6C, the facility may grant an individual access to location 660 when the identification presented is a military ID, yet deny the individual access to a location when the identification presented is a driver's license as shown in FIG. 6B. This may occur, for example, when the facility includes a rule regarding the type of identification scanned. In the depicted example, in order to grant Jeff Green access to Military Base 2, the operator may request to see and/or scan Jeff's military ID.

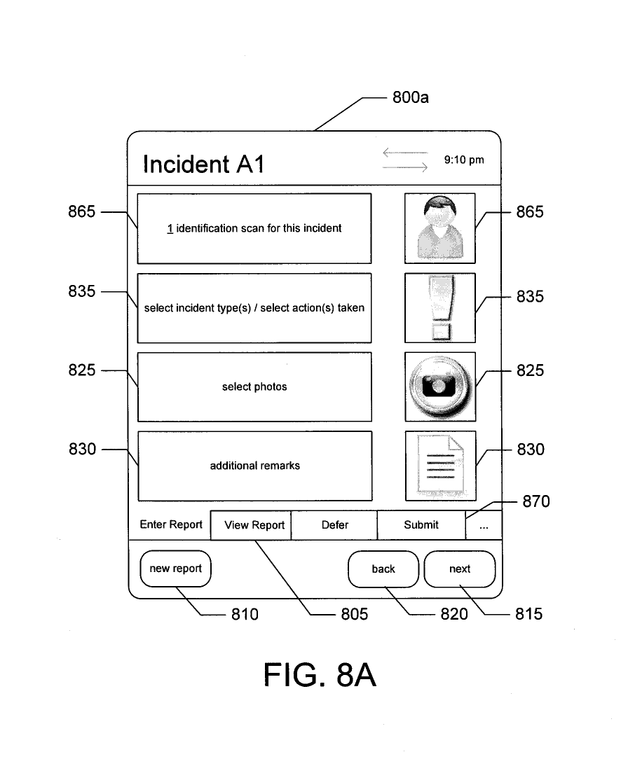

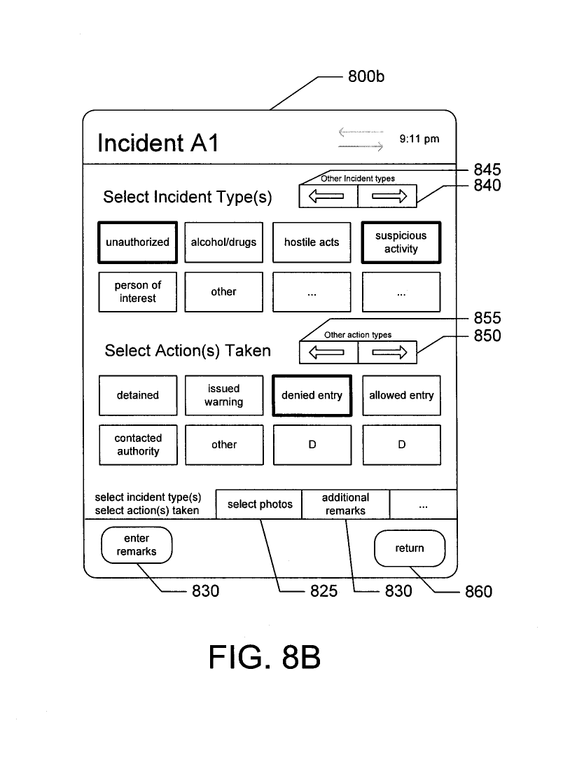

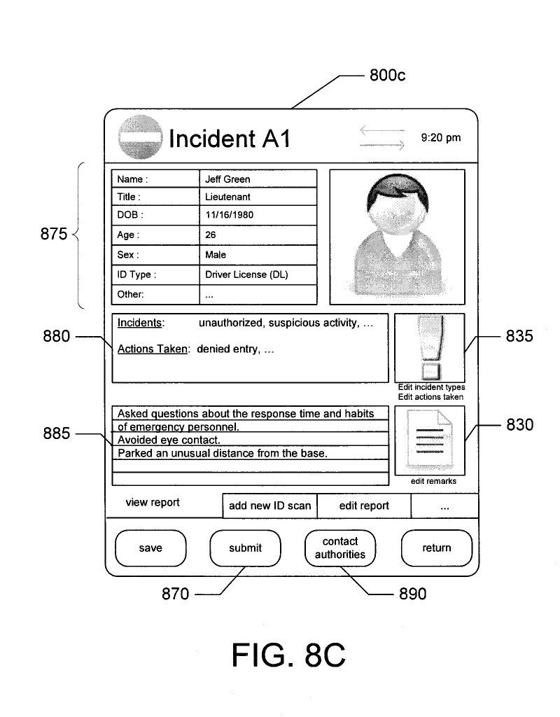

As described herein, in some embodiments, an operator may perform one or more actions after viewing the candidate record, such as detaining the individual or taking a picture of the individual. When the operator performs some action, the operator may record his or her actions by navigating to a display that provides an input mode (discussed further with respect to FIG. 8) using control 440. In some embodiments, the facility generates a report automatically without manual input from the operator. Also, in some embodiments, the facility automatically transmits the report to at least one authority without manual input from the operator. For example, when an individual is identified as a person of interest who poses a terrorist-related threat, the facility may automatically generate a report and transmit the generated report to one or more law enforcement agencies.

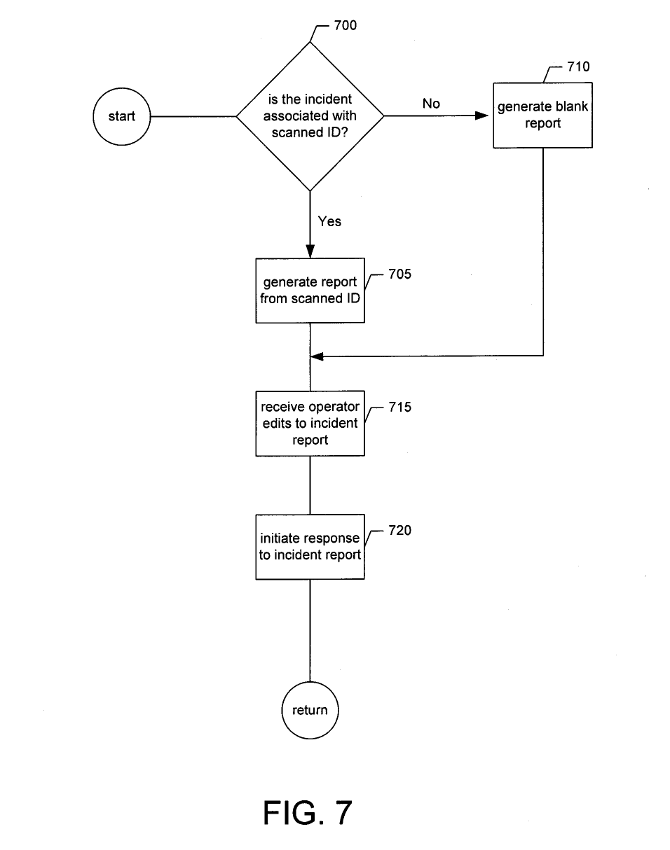

FIG. 7 is a flow chart of actions performed by the facility to enable an operator to generate an incident report and to initiate a response to the report. At decision block 700, the facility determines whether the incident is associated with a scanned identification record. If the facility determines that the incident is associated with a scanned identification record, the facility continues to block 705. Otherwise, the facility continues to block 710.

At block 705, the facility generates a report based on the scanned identification record. The report may be automatically populated with information that was scanned from the identification record or related to the scanning environment. For example, the report may include at least a portion of the decoded identification information, the time, date, location of the scan, etc. The report may also be automatically populated with information regarding the type of incident (e.g., “unauthorized”) and/or any actions typically performed by an operator in response to the incident (e.g., “denied entry”). The report may also include an indication of the identified and/or displayed candidate record(s) associated with the scan. A report may be automatically generated by the facility in response to the scanned identification information. A report may also be automatically generated by the facility when the operator decides to report an incident associated with a scanned identification record. For example, when an individual is authorized to access a location, but the operator suspects that the individual is under the influence of alcohol or drugs, the operator may decide to generate a report indicating his or her suspicions and any actions taken.

At block 710, the facility generates a blank report. For example, when an operator notices suspicious activity, the operator may report an incident even though it is not associated with a scanned identification record. After block 710, the facility continues to block 715.

At block 715, the facility receives operator edits to the incident report. FIGS. 8A and 8B show sample interface displays 800a and 800b produced by the facility to allow an operator to enter or edit an incident report. The operator may manually create a new incident report that is not associated with a scanned identification record by selecting button 810. Alternatively, the incident report process may be automatically initiated by the facility based on a scanned identification record. The operator may navigate incident report records presented on the scanning device using controls 815 and 820.

Display 800a presents the operator with a number of options to add various types of data to the incident report. An operator may attach or confirm the identification scan that is associated with the incident by selecting a control 865. The operator may select the incident type and enter the actions taken by selecting a control 835. Selecting control 835 takes the operator to display 800b. Display 800b is an interface that allows the operator to select or edit the incidents or actions associated with a report. One or more incidents and/or actions may be entered in a report by the operator. The operator enters the desired incident or actions by selecting the appropriate softkey associated with that incident or action. For example, display 800b shows that the “suspicious activity” and “unauthorized access” incidents have been associated with Incident A1 because the incident types are highlighted. Display 800b also shows that the individual was “denied entry” to the location or resource because the corresponding action taken softkey is highlighted. The facility may include a number of incident types and action types. An operator may navigate the various types of incidents using controls 840 and 845, and the various types of actions using controls 850 and 855. The operator may also enter remarks associated with the incident or action type by selecting an “enter remarks” button 830. When the operator is finished entering and/or editing the incidents or actions associated with the report, the operator may return to display 800a using control 860.

Returning to display 800a, in some embodiments the scanning device 100 is equipped with a camera. If the scanning device is equipped with a camera, the operator may take photographs using the camera. In addition, the operator may upload photographs from another device to the scanning device. If photographs are available, the operator can include the photographs in an incident report by selecting a control 825. For example, when an operator notices suspicious activity, the operator may take photographs of the activity using the scanning device and then include the photographs in an incident report. The operator may also select a control 830 to add additional remarks to the incident report. In some embodiments, the operator cannot alter certain automatically generated portions of the report; however, the operator can add additional details. For example, when an individual is denied access to a location and then acts suspiciously, the operator may edit the report to include an indication of the suspicious activity but may not be allowed to change any information associated with the identification of the individual.

The operator may select a view report button 805 to review an incident report. FIG. 8C shows a sample screenshot of an incident report. In particular, display 800c is a representative screen image that may be displayed by the facility for an incident associated with candidate record 605. An image of the candidate may be displayed along with one or more pieces of information 875 about the candidate. For example, the name, title, date of birth, age, sex, ID number and/or type, etc. may be displayed to the operator. The report may also include a display 880 of the incidents and actions taken by the operator. The operator may enter or edit the incident types or actions taken by selecting control 835. The report may also include a display 885 of operator remarks, if any, entered by the operator. The operator may select control 830 to enter or edit the remarks.

In some embodiments, the facility may be tailored such that certain information (e.g., an ID number, Social Security number, etc.) associated with a scan and/or a generated incident report is not stored, displayed, transmitted, and/or used inconsistently with government or private policies concerning privacy. For example, when storing a generated incident report (or when transmitting a report for further processing and/or storage), the facility may discard any ID number or Social Security number associated with the scan and/or generated incident report. By discarding certain types of information, the facility does not require prior notice through Federal Register publication of a System of Record (“SOR”), as would otherwise be required under the Privacy Act. For each type or group of information, the facility may be configured to restrict the storage, display, transmission, or use of the information.

Returning to FIG. 7, after the facility has received any edits to the incident report at block 715, a response may be initiated to the incident report at a block 720. The response may be manually initiated by the operator of the scanning device. For example, when the operator is satisfied with the incident report, the operator may select a submit button 870 to submit the incident report for additional processing. The operator may select a contact authorities button 890 to transmit the incident report to one or more authorities. In some embodiments, the operator may select the authorities to which the incident report is sent (not shown). While in other embodiments, the facility automatically selects the authorities to which the incident report is sent based on, for example, the type of incident, environmental information, location of the scanning device, etc. Alternatively, the response may be automatically initiated by the facility, such as when the incident exceeds a certain level of severity. That is, in some embodiments, the facility automatically informs the relevant authorities of incidents and/or the actions taken by the operator. One or more messages may be sent to the remote report/response service 270 that may start a predetermined chain of events. For example, a message may cause additional security forces to be automatically sent to the location where the scanning device is being operated. As another example, a message may cause a level of security to automatically be elevated at the location where the scanning device is being used. Alternatively, the one or more messages may merely serve a reporting function to enable corporate or government agencies to track incident statistics and resulting actions. For example, when the operator indicates that Joe Doe has been detained, the facility may transmit a message to the FBI agencies in Buffalo and Detroit if Joe Doe is on a list of parties wanted by the FBI.

In some embodiments, the operator may view incident reports that were not generated by the operator or in connections with the operator's activities. The reports may be, for example, accessed from a local or remote report data store (not shown). In some embodiments, access metrics are generated from incident reports. As a result, incidents that originally appear minor may be identified by the facility as important incidents that require a response. For example, if an individual attempts to access a location from various entry points, yet is denied access by each operator, the facility may generate a report indicating each of the access attempts and a potential threat. In some embodiments, the facility transmits the report to one or more authorities that may proactively respond to the attempts.

When the facility generates a report without manual input from the operator, the operator may continue his or her activities without interruption. After a report is generated, the operator may edit the report or add additional details regarding incidents and/or his or her actions associated with the incident. For example, the operator may record a description of the circumstances under which he or she has detained Joe Doe after scanning an identification record.

It will be appreciated by those skilled in the art that the components or services that are part of the facility or interact with the facility may be implemented by computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

Those skilled in the art will further appreciate that the facility or aspects of the facility disclosed herein may be implemented on any computing system or device. Suitable computing systems or devices include server computers, multiprocessor systems, microprocessor-based systems, network devices, minicomputers, mainframe computers, distributed computing environments that include any of the foregoing, and the like. Such computing systems or devices may include one or more processors that execute software to perform the functions described herein. Processors include programmable general-purpose or special-purpose microprocessors, programmable controllers, application specific integrated circuits (ASICs), programmable logic devices (PLDs), or the like, or a combination of such devices. Software may be stored in memory, such as random access memory (RAM), read-only memory (ROM), flash memory, or the like, or a combination of such components. Software may also be stored in one or more storage devices, such as magnetic or optical based disks, flash memory devices, or any other type of non-volatile storage medium for storing data. Software may include one or more program modules which include routines, programs, objects, components, data structures, and so on that perform particular tasks or implement particular abstract data types. The functionality of the program modules may be combined or distributed as desired in various embodiments.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

We claim:

1. A method in a computer system for controlling access to a location based on one or more access rules, the method comprising:
receiving identification information associated with an individual from a piece of identification;
comparing at least some of the received identification information with a first data set to assess the likelihood that the individual is a person of interest, the first data set including first data items, each first data item corresponding to a person of interest;
comparing at least some of the received identification information with a second data set to assess whether the individual is authorized to access the location, the second data set including second data items, each second data item corresponding to an authorized person; and
if the received identification information does not substantially match a first or second data item, applying one or more access rules to at least some of the read identification information to determine whether the individual is to be granted or denied access to the location.

2. The method of claim 1 further comprising:
if the received identification information substantially matches a first data item and does not substantially match a second data item, denying the individual access to the location.

3. The method of claim 1 further comprising:
if the received identification information substantially matches a second data item and does not substantially match a first data item, granting the individual access to the location.

4. The method of claim 1 further comprising receiving environmental information that is used to determine whether the individual is to be granted or denied access to the location.

5. The method of claim 4 wherein the environmental information identifies at least one of the one or more access rules that is applied to control access to the location that the individual is attempting to access.

6. The method of claim 4 wherein the environmental information comprises information indicating that the individual was previously denied access to the location at one or more entry points of the location within a predefined period of time.

7. The method of claim 1 wherein the one or more access rules have an order of precedence.

8. The method of claim 1 wherein at least one access rule is defined for the location for which the computer system is providing access-control service.

9. The method of claim 8 wherein the location is a government facility.

10. The method of claim 8 wherein the location is a port of entry.

11. The method of claim 8 wherein the location is a medical facility, a power plant, a court, a public facility, or a private facility.

12. The method of claim 1 wherein at least one access rule is based on a type of identification.

13. The method of claim 12 wherein the type of identification is a state ID, a military ID, a passport, a corporate ID, a credit card, a bank card, a loyalty card, or a student ID.

14. The method of claim 1 wherein at least one access rule is based on a threat level.

15. The method of claim 1 wherein at least one access rule is based on a time of day.

16. The method of claim 1 wherein at least one access rule is based on a calendar date.

17. The method of claim 1 further comprising:
if the received identification information substantially matches a first and second data item, applying the one or more access rules to at least some of the received identification information to determine whether the individual is to be granted or denied access to the location, wherein at least one of the one or more access rules is defined based on the severity of acts for which individual is suspected, charged, or convicted;
if the severity is within a predefined range, granting the individual access to the location; and
if the severity is not within the predefined range, denying the individual access to the location.

18. The method of claim 1 wherein the identification information is received from a portable device.

19. A system for controlling access to a location based on locally-defined access rules, the system comprising:
a device for reading identification information associated with an individual from an identification document; and
a processing component for:
comparing at least some of the read identification information with a data set containing records corresponding to persons of interest to determine whether the individual is a person of interest;
comparing at least some of the read identification information with a data set containing records corresponding to authorized persons to determine whether the individual is authorized to access the location; and
if the read identification information does not substantially match a record corresponding to a person of interest or a record corresponding to an authorized person, applying locally-defined access rules to at least some of the read identification information to determine whether the individual is to be granted or denied access to the location.

20. The system of claim 19 wherein the processing component denies the individual access to the location if the read identification information substantially matches a record corresponding to a person of interest and does not substantially match a record corresponding to an authorized person.

21. The system of claim 19 wherein the processing component grants the individual access to the location if the read identification information substantially matches a record corresponding to an authorized person and does not substantially match a record corresponding to a person of interest.

22. The system of claim 19 further comprising a receiving component for receiving environmental information that is used to determine whether the individual is to be granted or denied access to the location.

23. The system of claim 22 wherein the environmental information identifies at least one locally-defined access rules that is to be applied to control access to the location in which the device is operating.

24. The system of claim 22 wherein the environmental information comprises information indicating that the individual was denied access to the location at one or more entry points of the location.

25. The system of claim 19 wherein the locally-defined access rules have an order of precedence.

26. The system of claim 19 wherein at least one locally-defined access rule is based on a type of the identification record.

27. The system of claim 26 wherein the identification record is a state ID, a military ID, a passport, a corporate ID, a credit card, a bank card, a loyalty card, or a student ID.

28. The system of claim 19 wherein at least one locally-defined access rule is based on a threat level.

29. The system of claim 19 further comprising globally-defined access rules, and wherein at least one globally-defined access rule used to determine whether the individual is to be denied or granted access to the location.

30. The system of claim 19 wherein the location in which at least one of the locally-defined rules is defined for is a government facility.

31. The system of claim 19 wherein the location in which at least one of the locally-defined rules is defined for is a port of entry.

32. The system of claim 19 wherein the identification information is read using a scanning component of the device, and wherein the scanning component comprises at least one of a digital scanner, a camera, a magnetic strip reader, an optical character reader, a bar code scanner, or an RFID reader.

33. A computer-readable storage medium encoded with instructions that, when executed by a computing system, cause the computing system to control access to a location based on at least one locally-defined access rule, by:
reading information from an identification record presented by an individual;
comparing at least some of the read identification information with a first data set to determine whether the individual is a person of interest, the first data set including first data items, each first data item corresponding to a person of interest;
comparing at least some of the read identification information with a second data set to determine whether the individual is authorized to access the location, the second data set including second data items, each second data item corresponding to an authorized person;
if the read identification information substantially matches a first data item and does not substantially match a second data item, providing an indication that the individual is to be denied access to the location;
if the read identification information substantially matches a second data item and does not substantially match a first data item, providing an indication that the individual is to be granted access to the location; and
if the read identification information does not substantially match a first or second data item, applying the at least one locally-defined access rule to at least some of the read identification information to determine whether the individual it to be granted or denied access to the location.

34. The computer-readable storage medium of claim 33 further comprising:
if the read identification information substantially matches a first and second data item, applying the at least one locally-defined access rule to at least some of the read identification information to determine whether the individual is to be granted or denied access to the location.
